(19) United States
(12) Patent Application Publication
(10) Pub. No.: US 2013/0014717 A1
(43) Pub. Date: Jan. 17, 2013

(54) LASER IGNITION DEVICE FOR AN INTERNAL COMBUSTION ENGINE

(71) Applicants: Mathias Moenster, Stuggart (DE); Werner Herden, Gerlingen (DE); Manfred Vogel, Ditzingen (DE)

(72) Inventors: Mathias Moenster, Stuggart (DE); Werner Herden, Gerlingen (DE); Manfred Vogel, Ditzingen (DE)

(21) Appl. No.: 13/519,278

(22) PCT Filed: Dec. 3, 2010
(86) PCT No.: PCT/EP2010/068854

§ 371 Date: Sep. 28, 2012

(30) Foreign Application Priority Data
Dec. 28, 2009 (DE) 10 2009 055 334.7
Aug. 27, 2010 (DE) 10 2010 039 877.2

(51) Int. Cl. F02P 23/04

(52) U.S. Cl. 123/143 B

(57) ABSTRACT

A laser ignition device for an internal combustion engine, in particular of a motor vehicle, having a laser device for generating laser pulses, and having a pumped light source for optically pumping the laser device. A photodiode system is situated in the area of an optical connection between the pumped light source and the laser device in such a way that pumped radiation generated by the pumped light source and the laser radiation generated by the laser device may each be irradiated at least partially onto a photodiode of the photodiode system.

### FIELD OF THE INVENTION

The present invention relates to a laser ignition device for an internal combustion engine, in particular of a motor vehicle, having a laser device for generating laser pulses, and having a pumped light source for optically pumping the laser device.

### BACKGROUND INFORMATION

A laser ignition device of this type is described in German Patent Application No. DE 10 2007 044 011 A1.

### SUMMARY

An object of the present invention to improve a laser ignition device in such a way that an easier and more reliable diagnosis of the operation of the laser ignition device is possible.

According to an example embodiment of the present invention, this object may be achieved in the laser ignition device in that a photodiode system is situated in the area of an optical connection between the pumped light source and the laser device in such a way that pumped radiation generated by the pumped light source and the laser radiation generated by the laser device may each be irradiated at least partially onto a photodiode of the photodiode system. In this way, it is advantageously possible to monitor the laser ignition pulses generated by the laser device and the pumped radiation provided by the pumped light source.

In one particularly small-sized variant of the laser ignition device according to the present invention, it is provided that the photodiode is situated in the area of an optical terminal of the pumped light source or the laser device. The photodiode may preferably also be directly integrated into the appropriate components.

In another particularly advantageous variant of the laser ignition device according to the present invention, it is provided that the optical connection between the pumped light source and the laser device has an optical cross-section converter, and that the photodiode is situated in the area of the cross-section converter, preferably directly on the cross-section converter. It has been recognized according to the present invention that in the area of the cross-section converter pumped radiation and laser pulses generated by the laser device emanate from the cross-section converter at least in the form of scattered light, so that they may be detected particularly efficiently and easily with the aid of a photodiode.

A particularly precise evaluation of the laser ignition pulses generated by the laser device results according to another advantageous variant of the present invention in that the photodiode system has a high-pass filter and/or a bandpass filter for filtering an output signal of the photodiode. It has been recognized according to the present invention that when the lower threshold frequency of the high-pass filter or the bandpass filter is selected appropriately, it may be achieved that the typically relatively low-frequency portions of the electrical output signal of the photodiode, which are due to the irradiated pumped radiation portions, do not yet result in a pre-saturation of the photodiode, whereby the evaluability of the relatively high-frequency signal portions is ensured, which result from the irradiation of the laser ignition pulses onto the photodiode.

In another advantageous variant of the present invention, a particularly simple circuit configuration is provided in that an inductive element is switched in parallel to the photodiode and an ohmic load resistor. By appropriately selecting the inductivity of the inductive element, which may be designed as a conventional coil, for example, the interfering low-frequency pumped light portions of an electrical output signal of the photodiode may be short-circuited so that they cannot contribute to the pre-saturation of the photodiode. However, higher-frequency portions of the photodiode output signal, which are due to the laser ignition pulses, generate in contrast a greater voltage drop at the parallel circuit of the inductive element and the load resistor and are thus advantageously precisely evaluatable.

The inductive element is to be selected according to the signal frequencies used for the pumped radiation and the laser ignition pulses of the laser device in such a way that the frequency portions of the pumped radiation are predominantly short-circuited by the high-pass filter or the bandpass filter so that no undesirable pre-saturation of the photodiode results due to the pumped radiation. Typically, signal portions of the electrical output signal of the photodiode which are due to the irradiation of the pumped light may lie in the range of approximately 100 kHz, while those signal portions of the electrical output signal of the photodiode which are due to the irradiation by the laser ignition pulses of the laser device lie in the range of approximately 1 GHz.

In another very advantageous variant of the present invention, a series circuit including at least one inductive element and at least one ohmic resistor are switched in parallel to the photodiode. By appropriately selecting the ohmic resistor of this series circuit it may be achieved that the relatively low-frequency signal portions of the photodiode output signal, which contribute to the pre-saturation of the photodiode, are not completely short-circuited. As a result, the evaluation of the pumped radiation, for example a check for the presence of pumped radiation, is also possible with the aid of an evaluation circuit situated downstream from the photodiode system. The ohmic resistor of the series circuit should not be selected to be too large so that the photodiode does not already transition into a state of saturation due to the spectral portions of the pumped radiation.

Another advantageous variant of the present invention provides that a first series circuit including at least one inductive element and at least one switch, and at least one second series circuit including at least one ohmic resistor and at least one switch are each switched in parallel to the photodiode. The filter characteristic of the photodiode system according to the present invention may be modified with the aid of this circuit configuration.

For example, the second series circuit may be actively switched during the optical pumping of the laser device by closing the switch of the second series circuit so that the ohmic resistor of the second series circuit is applied in parallel to the photodiode. A voltage value which is proportional to the optical pumping power of the pumped light source may be detected at the ohmic resistor. Subsequently, at a defined time, for example, prior to the estimated occurrence of the generation of a laser ignition pulse by the laser device, the second series circuit may be deactivated by opening the switch contained therein, while the switch of the first series circuit is closed at the same time, to enable a particularly precise detection of the laser ignition pulse with the aid of the high-pass characteristic, repeatedly described above, of the first series circuit having an inductivity.

A load resistor is also switched in parallel to the photodiode. The load resistor converts the current generated by the photodiode into a voltage which is metrologically detectable by a control device of the laser ignition device, for example. The load resistor usually represents an inner resistance of a corresponding measuring device of the control device; it may, however, also be implemented in a discrete form, in particular in the proximity of the photodiode.

The load resistor and the induction values of the inductive elements, and, if necessary, of other ohmic resistors of the photodiode system according to the present invention must be adapted in a conventional manner so that a desired filter characteristic is achieved. Moreover, the load resistance must, on the one hand, be selected to be low enough for the circuit in conjunction with the capacitance of the photodiode (low pass) to be fast enough to detect the ignition laser pulse. On the other hand, the load resistance must be selected to be high enough that a sufficient voltage level for a reliable detection is generatable. Preferred values for the load resistance lie in the range of 50Ω to 2 kΩ.

In another particularly advantageous specific embodiment of the laser ignition device according to the present invention, it is provided that at least one inductive element of the photodiode system is situated at a distance from the photodiode. For example, the inductive element and/or at least one series circuit, e.g., having a switch, inductive elements, or ohmic resistors, may be situated in a control device of the laser ignition device, while only the photodiode is situated directly in the area of the optical connection or the optical cross-section converter.

According to another specific embodiment, the photodiode system according to the present invention is designed to operate the photodiode without a bias voltage, thus resulting in a circuit configuration having particularly little complexity. Due to the high-pass configuration according to the present invention, a pre-saturation of the photodiode due to application with pumped light may still be avoided so that even laser ignition pulses are well detectable.

Further advantages and advantageous embodiments of the present invention are derivable from the figures and the description below. All of the features disclosed in the figures and the description, and the patent claims may be used in accordance with the present invention both individually and in any combination with each other.

### BRIEF DESCRIPTION OF THE DRAWINGS

FIG. 1 schematically shows an internal combustion engine in a first specific embodiment of the laser ignition device according to the present invention.

FIG. 2 shows another specific embodiment of the laser ignition device according to the present invention.

FIGS. 3a, 3b, and 3c each show different circuit configurations of a photodiode system according to the present invention.

FIGS. 4a through 4d each show different time curves of the electrical operating variables according to another specific embodiment.

### DETAILED DESCRIPTION OF EXAMPLE EMBODIMENTS

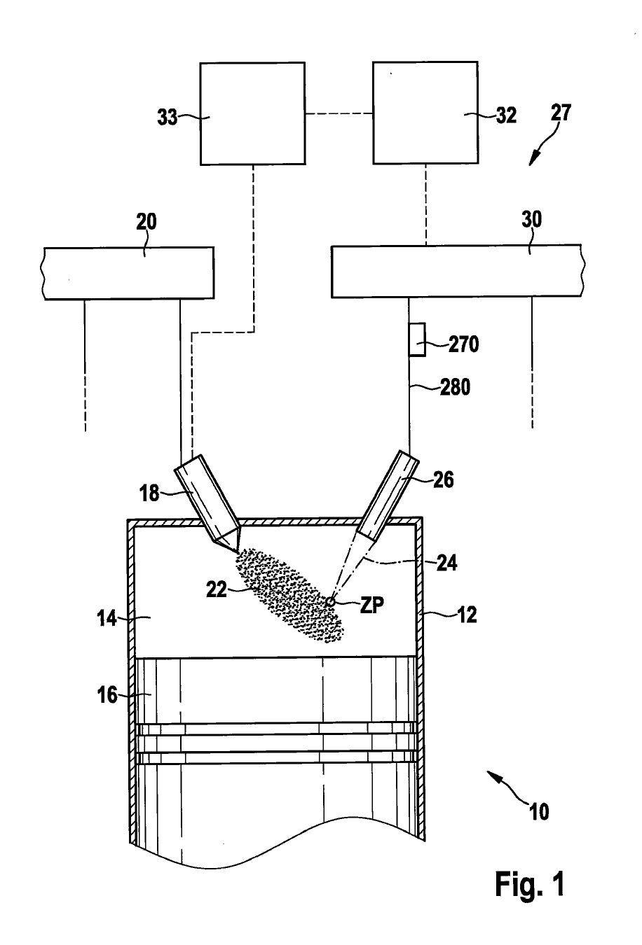

An internal combustion engine is identified overall with reference numeral 10 in FIG. 1. It may be used for driving a motor vehicle (not illustrated). Internal combustion engine 10 includes multiple cylinders, only one of which is labeled with reference numeral 12 in FIG. 1. A combustion chamber 14 of cylinder 12 is delimited by a piston 16. Fuel reaches combustion chamber 14 directly through an injector 18, which is connected to a fuel pressure accumulator 20 known as a rail.

Fuel 22 injected into combustion chamber 14 is ignited with the aid of a laser pulse 24 which is emitted into combustion chamber 14 by an ignition device 27 which includes a laser device 26. For this purpose, laser device 26 is supplied with pumped light via a fiber optic device 280, the pumped light being made available by a pumped light source 30. Pumped light source 30 is controlled by a laser control device 32. Pumped light source 30 may have a semiconductor diode laser for generating the pumped light, for example. Laser control device 32 is connected to a motor control unit 33 via a communication line which is indicated in FIG. 1 as a dashed line and is not identified in greater detail. Motor control unit 33 controls injector 18. Optionally, the laser control device and the motor control unit may be integrated into one control unit.

Laser device 26 has, for example, a laser-active solid (not illustrated) having a passive Q-switch, which forms an optical resonator together with an input mirror and an output mirror. When pumped light, which is generated by pumped light source 30 and which is irradiated in particular longitudinally into the optical resonator, is applied to laser device 26, laser device 26 generates a laser pulse 24 in a conventional manner which is focused through a focusing lens onto an ignition point ZP located in combustion chamber 14. The components present in a housing of laser device 26 are separated from combustion chamber 14 by a combustion chamber window. Neodymium or ytterbium doped material is preferably used as the laser-active solid.

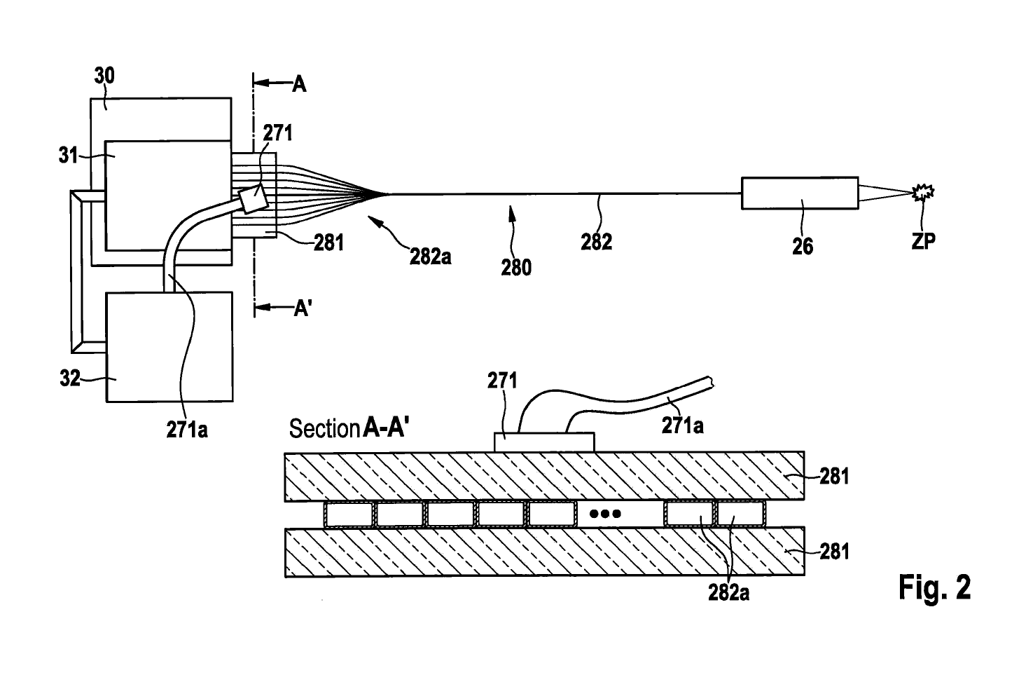

According to the present invention, a photodiode system 270 is provided which is situated in the area of optical connection 280 between pumped light source 30 and laser device 26 in such a way that the pumped radiation generated by pumped light source 30 and the laser radiation generated by laser device 26 may each be irradiated at least partially onto a photodiode 271 (FIG. 2) of photodiode system 270.

In this way, an operation of pumped light source 30 and/or of laser device 26 may advantageously be monitored. For example, photodiode system 270 according to the present invention may convert the particular optical signals into an electrical output signal which is evaluatable by control device 32 in a conventional manner.

In one variant according to the present invention, which is of particularly little complexity with regard to construction, it is provided that photodiode 271 is situated in the area of an optical terminal of pumped light source 30 or laser device 26. Photodiode 271 is electrically connected to laser control device 32 via electrical connection lines 271a.

FIG. 2 shows another variant of the present invention in which optical connection 280 between laser device 26 and pumped light source 30 is implemented with the aid of a bundle 282 made of optical fibers 282a. Optical connection 280 furthermore has an optical cross-section converter 281 which adapts the cross section of several optical fibers 282a to a semiconductor laser diode system 31 of pumped light source 30 in a conventional manner. Cross-section converter 281 converts the generally circular cross section of bundled optical fibers 282a, as is apparent from FIG. 2, into a generally rectangular or linear configuration so that individual optical fibers 282a each advantageously face different emitters of semiconductor diode laser 31, in particular semiconductor diode laser ingots.

FIG. 2 shows a section through cross-section converter 281 along lines A-A′.

Photodiode 271 of photodiode system 270 according to the present invention is advantageously situated directly on optical cross-section converter 281 in this variant according to the present invention, so that it may absorb light scattered in cross-section converter 281. According to studies by the applicant, the light scattered in cross-section converter 281 contains portions of the pumped light made available by pumped light source 30 and portions of laser ignition pulses 24 generated by laser device 26, the intensity of the scattered pumped light typically being significantly higher than the intensity of the scattered laser ignition pulses.

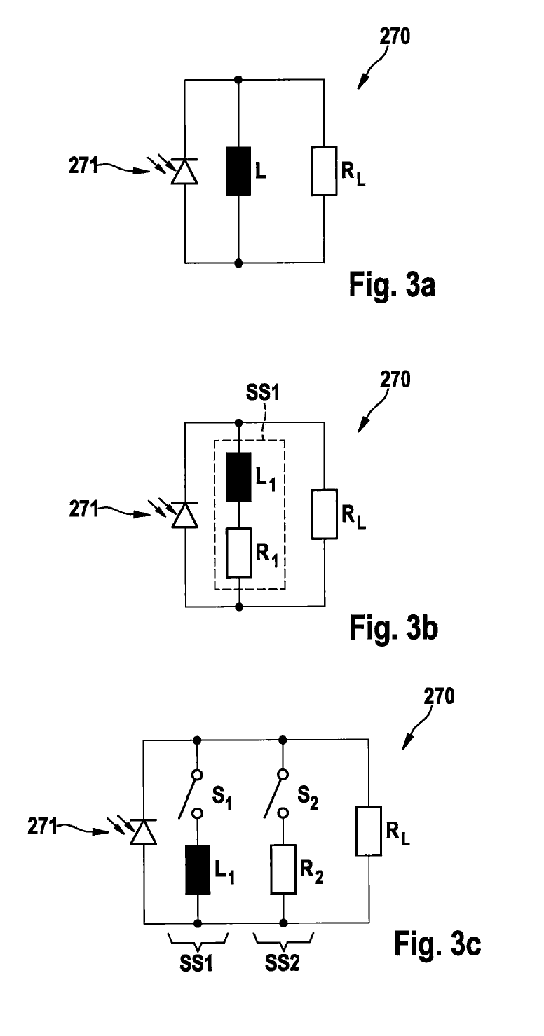

FIG. 3a shows a first specific embodiment of photodiode system 270 according to the present invention having photodiode 271 which may be a PIN (positive intrinsic negative) diode, for example. Photodiode system 270 according to the present invention has an inductive element L which is switched in parallel to photodiode 271 as is apparent from FIG. 3a, thus resulting in a high-pass filter configuration. It has been recognized according to the present invention that this circuit configuration advantageously short-circuits those signal portions of the photodiode output signal (photodiode current) which have relatively low frequency portions, while higher-frequency signal portions of the photodiode current are not short-circuited. In this way, photodiode 271 may be advantageously prevented from pre-saturation due to mere application of pumped light; pre-saturation could disadvantageously result in laser ignition pulse 24, which usually chronologically follows the pumped light irradiation, being no longer detectable at all. On the one hand, inductive element L thus prevents the pre-saturation of photodiode 271 due to the relatively low-frequency signal portions which are generated by the pumped light in photodiode 271. On the other hand, the relatively high-frequency signal portions, which are caused by laser ignition pulses 24 lying in the nanosecond range, experience a corresponding voltage drop, which may be well evaluated, at the parallel circuit of inductive element L and load resistor RL. It is not possible to completely avoid the parasitic ohmic line resistances within inductive element L (coil). According to the present invention, line resistances below 10 mΩ are preferred.

Load resistor RL does not have to be designed as a separate, discrete component, but may also already be contained, in a conventional manner, in an input module of control device 32, for example, which implements an evaluation of the electrical signals generated by photodiode 271. Load resistor RL may also be understood as an input impedance of such an input module.

In another variant of photodiode system 270 according to the present invention, FIG. 3b shows a series circuit SS1 including a first inductivity L1 and a first ohmic resistor R1. In contrast to the configuration according to FIG. 3a, series circuit SS1 has not only a purely inductive nature, so that the relatively low-frequency signal portions which are short-circuited primarily by inductive component L1 of series circuit SS1 and which are caused by the pumped light in photodiode 271 also result in a corresponding voltage drop at ohmic resistor R1 and are thus also detectable by control device 32. This means that in the configuration according to FIG. 3b, the presence of pumped light and the presence of laser radiation, which corresponds with laser ignition pulses 24 generated by laser device 26, may be derived from the evaluation of the voltage drop at load resistor RL.

Advantageously, ohmic resistor R1 of series circuit SS1 is to be selected in such a way that the signal portions generated by the pumped light are still predominately short-circuited, i.e., only a small portion of the low-frequency signal portions is detectable in order to avoid the described pre-saturation of photodiode 271.

FIG. 3c shows another photodiode system 270 in which two series circuits SS1, SS2 are switched in parallel to photodiode 271.

First series circuit SS1 has a switch S1 and an inductive element L1, while the second series circuit has a second switch S2 and an ohmic resistor R2 situated in series thereto. Switches S1, S2 may, for example, be designed as transistors, the particular transistors being controllable by laser control device 32. MOSFETS are preferably used as switches S1, S2, since they are more cost-effective on the one hand and are low-resistance during bandpass operation on the other hand.

Photodiode system 270 according to FIG. 3c is configurable particularly advantageously with regard to its filtering characteristic. For example, in a first operation mode first switch S1 may be open and second switch S2 may be closed during a pumping operation, in which laser device 26 is pumped optically with the aid of the pumped light made available by pumped light source 30, thus resulting in a relatively low-resistance system overall due to ohmic resistors R2, RL. This low-resistance system advantageously allows for a prevention of a saturation of photodiode 271 solely due to the pumped light signal portions.

A voltage drop occurring at ohmic resistors R2, RL may, however, still be evaluated, the voltage drop providing information on the intensity of the pumped light or the presence of pumped light generally.

In a second operation mode, second switch S2 is open and first switch S1 is closed. This configuration generally corresponds to the circuit configuration according to FIG. 3a and, due to the high-pass characteristic, which is contingent to inductive element L1, advantageously enables a filtering of the output signals of photodiode 271 in such a way that only the relatively high-frequency signal portions, which are caused by laser ignition pulses 24 of laser device 26, drop at load resistor RL, while the relatively low-frequency signal portions, which are due to the pumped light, are short-circuited by inductive element L1 of first series circuit SS1 as described previously so that they do not lead to the undesirable pre-saturation of photodiode 271.

The switch-over between the two operation modes advantageously takes place sufficiently early before an anticipated ignition point at which laser device 26 generates laser ignition pulse 24. The switch-over should particularly take place in time before the anticipated ignition point so that the high-pass filter system of photodiode system 270 has time to transiently function and, possibly, to reduce the amount of charge carriers stored in the PN junction of photodiode 271, so that a maximum sensitivity of photodiode 271 for detecting laser ignition pulse 24 may be ensured.

In a third operation mode, first switch S1 and second switch S2 are open so that the photodiode current flows only through load resistor RL. If RL is larger than R2, a greater overall resistance, which allows relatively weak optical signals to be detected, may be implemented in this operation mode compared to the first operation mode. For example, the relatively weak fluorescence signal of the laser-active solid may be detected after switching off the pumped light. Here, the goal of the pumping procedure is just to generate a population inversion in the laser-active solid for generating fluorescence without an ignition pulse being triggered by the passive Q-switch.

The induction values of inductive element L are preferably selected from the range of approximately 0.5 μH (microhenry) to approximately 20 μH, a value of approximately 5 μH being particularly preferred. In this case, a particularly efficient detection of laser ignition pulses 24 by photodiode system 270 takes place.

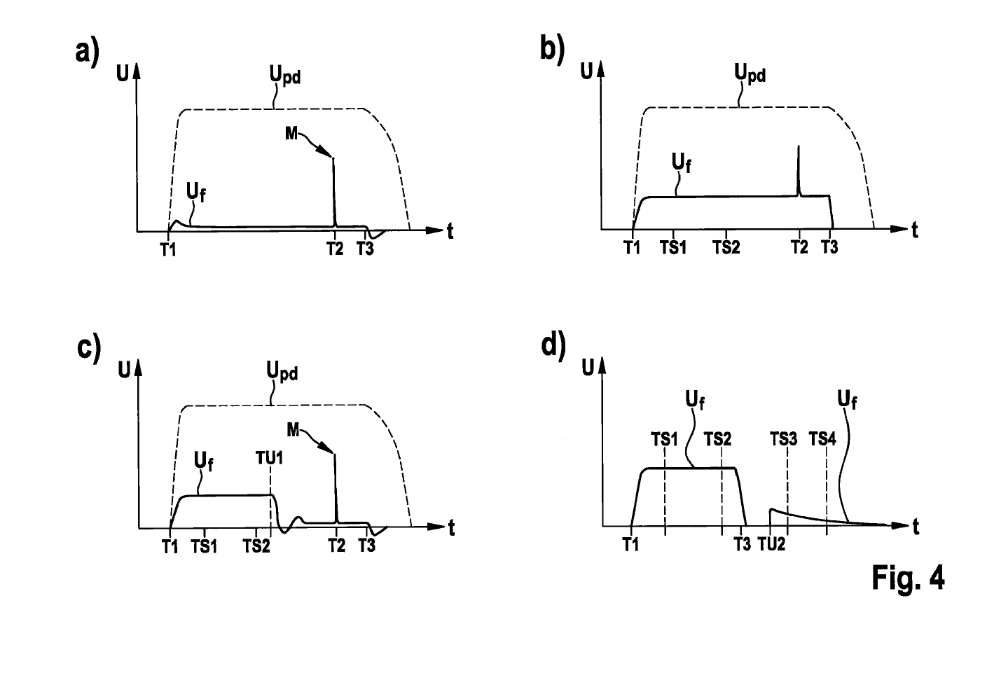

Subsequently, other specific embodiments are described with reference to FIGS. 4a through 4d.

Dashed line Upd in FIG. 4a shows a time curve of the photodiode voltage the way it appears completely without the filtering according to the present invention previously described. The same time curve is also plotted in FIGS. 4b and 4c. The ignition point may consequently not be measured here.

In contrast to that, solid line Uf in FIG. 4a shows the photodiode voltage in the case of the parallel circuit of a coil L according to FIG. 3a. Ignition point T2, at which laser ignition pulse 24 is emitted, may be measured by using a triggering or an interruption unit of laser control device 32, for example, which evaluates time curve Uf (solid line in FIG. 4a) filtered according to the present invention and recognizes clearly delimited local maximum M at point in time T2.

Reference symbol T1 in FIG. 4a represents the switching-on point in time of the pumped light source. Immediately after T1, the transient condition of the high pass according to FIG. 3a is apparent in filtered voltage curve Uf. As previously described, T2 represents the ignition point. T3 identifies the switching-off point in time of the pumped light source. Following T3, the decay of the high pass according to FIG. 3a is recognizable.

FIG. 4b shows a time curve of filtered photodiode voltage Uf the way it appears in the case of a parallel circuit of a series circuit including coil L1 and low-resistance resistor R1 according to FIG. 3b. TS1 indicates the starting point in time for a measured value sampling, while TS2 defines the stopping point in time for the measured value sampling. In the time window (TS1; TS2), >=1 measured values are detected from which the presence of pumped light may be deduced. A local maximum, which corresponds with the occurrence of laser ignition pulse 24, is also detectable at time T2 from curve Uf.

FIG. 4c shows a time curve of filtered photodiode voltage Uf the way it appears if a circuit according to FIG. 3c is used. A first operation mode is set in the time interval from T1 to TU1, namely a measured value sampling in the sampling window (TS1; TS2). In this first operation mode, switch S1 is open and switch S2 is closed so that the presence of the pumped radiation may be advantageously deduced from curve Uf; a diagnosis of the pumping operation is therefore possible.

A second operation mode is set from TU1 to T3 in which ignition point T2 is measured. In this second operation mode, switch S2 is open and switch S1 is closed so that local maximum M is detectable particularly reliably from curve Uf at time T2.

Point in time TU1 represents here a switch-over point in time, i.e., closing of S1 and opening of S2. Following the switch-over, a transient condition of the high pass filter (FIG. 3c) is recognizable (cf. the variations in time curve Uf immediately after TU1).

FIG. 4d shows, again in the form of a solid line Uf, the time curve of the photodiode voltage when a circuit according to FIG. 3c) of the draft application is used. A fluorescence signal generated by laser device 26 is to be detected in the present case.

For this purpose, a measured value sampling of time curve Uf, the way it takes place due to the optical pumping, is carried out in sampling window TS1 to TS2 in a first operation mode from T1 to T3. Switch S1 (FIG. 3c) is open and switch S2 is closed.

Subsequently, in a third operation mode for points in time t>TU2, in which switch S1 is open and switch S2 is closed, a measured value sampling with >=1 measured value is carried out for the fluorescence measurement in sampling window TS3 to TS4. During the third operation mode starting from TU2, optical pumping no longer takes place, since this would make the detection of the fluorescence signal more difficult or impossible. It is only necessary to pump until T3 in order to excite the laser for fluorescence.

Photodiode system 270 according to the present invention advantageously allows an evaluation of laser ignition pulses 24, the pumped light of the pumped light source 30 and/or the fluorescent light of the laser device, without the evaluation of laser ignition pulses 24 being impaired by a pre-saturation of photodiode 271 due to signal portions of the pumped light. This is particularly advantageous when the pumped light power irradiated into the photodiode is significantly greater than the corresponding ignition light power or fluorescent light power.

The photodiode system according to the present invention may be particularly flexibly divided up into different modules;

for example, only photodiode 271 is provided in the area of optical connection 280 (FIG. 1) or of optical cross-section converter 281 (FIG. 2), while remaining components L, L1, RL, SS1, SS2 of optical connection 280 or of cross-section converter 281 are situated at a distance, for example integrated into control device 32.

According to another specific embodiment, the photodiode system according to the present invention is designed to operate photodiode 271 without a bias voltage, thus resulting in a circuit configuration being of particularly little complexity (cf. FIGS. 3a, 3b, 3c). Due to the high-pass configuration according to the present invention, a pre-saturation of photodiode 271 due to application with pumped light may still be avoided so that even relatively short laser ignition pulses 24 are well detectable.

1-15. (canceled)

16. A laser ignition device for an internal combustion engine of a motor vehicle, comprising:
a laser device to generate laser pulses;
a pumped light source to optically pump the laser device; and
a photodiode system situated in an area of an optical connection between the pumped light source and the laser device in such a way that pumped radiation generated by the pumped light source and the laser radiation generated by the laser device may each be irradiated at least partially onto a photodiode of the photodiode system.

17. The laser ignition device as recited in claim 16, wherein the photodiode is situated in an area of an optical terminal of one of the pumped light source or the laser device.

18. The laser ignition device as recited in claim 16, wherein the optical connection between the pumped light source and the laser device has an optical cross-section converter, and the photodiode is situated in an area of the cross-section converter.

19. The laser ignition device as recited in claim 18, wherein the photodiode is situated directly on the cross-section converter.

20. The laser ignition device as recited in claim 16, wherein the photodiode system has at least one of a high-pass filter, and a bandpass filter, to filter an output signal of the photodiode.

21. The laser ignition device as recited in claim 20, wherein an inductive element is switched in parallel to the photodiode.

22. The laser ignition device as recited in claim 20, wherein a series circuit including at least one inductive element and at least one ohmic resistor is switched in parallel to the photodiode.

23. The laser ignition device as recited in claim 20, wherein a first series circuit including at least one inductive element and at least one switch, and at least one second series circuit including at least one ohmic resistor and at least one switch are switched in parallel to the photodiode.

24. The laser ignition device as recited in claim 23, wherein a load resistor is switched in parallel to the photodiode.

25. The laser ignition device as recited in claim 16, wherein at least one inductive element is situated at a distance from photodiode.

26. The laser ignition device as recited in claim 25, wherein at least one of the inductive element and at least one series circuit is situated in a control device of the laser ignition device.

27. The laser ignition device as recited in claim 20, wherein the photodiode system is configured to operate the photodiode without a bias voltage.

28. A method for operating a laser ignition device for an internal combustion engine of a motor vehicle, comprising:
generating laser pulses using a laser device;
optically pumping the laser device using a pumped light source;
irradiating at least partially onto a photodiode of a photodiode system situated between the pumped light source and the laser device pumped radiation generated by the pumped light source; and
evaluating an output signal of the photodiode system to deduce therefrom an operating state of the laser ignition device.

29. The method as recited in claim 28, wherein the photodiode system has at least one of a high-pass filter and a bandpass filter, to filter the output signal of the photodiode system, and the method further comprising:
modifying a filter characteristic of the at least one of the high-pass filter and the bandpass filter at least one of during optical pumping of the laser device, or following the optical pumping of the laser device by switching on or switching off individual filter components with the aid of at least one switch.

30. The method as recited in claim 29, wherein a first series circuit including at least one inductive element and at least one switch, and at least one second series circuit including at least one ohmic resistor and at least one switch are switched in parallel to the photodiode, in a first operation mode during a pumping operation, during which the laser device is optically pumped, the first switch being open and the second switch being closed, and in a second operation mode, the second switch being open and the first switch being closed.

31. The method as recited in claim 30, wherein, starting from the first operation mode, in a third operation mode, the first switch and the second switch are open to detect a fluorescence signal of a laser-active solid of the laser device after switching off the pumped light at the end of the first operation mode.
